(19) United States
(12) Patent Application Publication
(10) Pub. No.: US 2020/0412465 A1
(43) Pub. Date: Dec. 31, 2020

(54) RADIO WAVE ENVIRONMENT ANALYZER AND RADIO WAVE ENVIRONMENT ANALYSIS METHOD

(71) Applicant: Panasonic Intellectual Property Management Co., Ltd., Osaka (JP)

(72) Inventor: Taichi HAMABE, Kanagawa (JP)

(21) Appl. No.: 17/021,097

(22) Filed: Sep. 15, 2020

Related U.S. Application Data
(63) Continuation of application No. PCT/JP2019/006659, filed on Feb. 21, 2019.

(30) Foreign Application Priority Data
Mar. 20, 2018 (JP) 2018-053516

(51) Int. Cl. H04B 17/318; H04B 17/391

(52) U.S. Cl. CPC H04B 17/318; H04B 17/3912

(57) ABSTRACT

A radio wave environment analyzer includes: a memory configured to hold measurement result data in which radio wave environment measurement results are associated with position information of a plurality of measurement points, the radio wave environment measurement results being obtained at the respective measurement points as a result of transmission of radio waves from a radio transmitter installed in an area having the plurality of measurement points; and a processor configured to perform, using a prescribed condition, a simulation of radio wave environments to be obtained at respective locations in the area as a result of transmission of radio waves from the radio transmitter. The processor performs the simulation repeatedly while changing the prescribed condition until a difference between the measurement result data and a result of the simulation at part of the plurality of measurement points becomes smaller than or equal to a prescribed value.

### CROSS-REFERENCE TO RELATED APPLICATIONS

This application is a continuation of PCT International Patent Application No. PCT/JP2019/006659 filed on Feb. 21, 2019, which claims the benefit of priority of Japanese Patent Application No. 2018-053516 filed on Mar. 20, 2018, the enter contents of which are incorporated herein by reference.

### FIELD

The present disclosure relates to a radio wave environment analyzer and a radio wave environment analysis method.

### BACKGROUND

JP-A-2006-125951 discloses a technique for detecting a two-dimensional position of a cart that is mounted with a wireless LAN automatic site survey apparatus having an antenna for receiving a signal from a wireless LAN relay apparatus and electric field strength at that position while the cart is running in a measurement area. Furthermore, in JP-A-2006-125951, a detected position and electric field strength are associated with each other and an image of a two-dimensional electric field strength distribution is produced.

### SUMMARY

The concept of the present disclosure mas been conceived in the above-described circumstances in the art, and an object of the disclosure is to provide a radio wave environment analyzer and a radio wave environment analysis method that support visualization of a highly accurate radio wave environment simulation result through efficient cooperation between measurement results at a plurality of example measurement points and a simulation in an entire area that is a target of a radio wave environment simulation without making actual measurements in the entire area.

The disclosure provides a radio wave environment analyzer including: a memory which holds measurement result data in which radio wave environment measurement results are associated with position information of a plurality of measurement points, the radio wave environment results being obtained at the respective measurement points as a result of transmission of radio waves from a radio transmitter installed in an area having the plurality of measurement points; and a processor configured to perform, using a prescribed condition, a simulation of radio wave environments to be obtained at respective locations in the area as a result of transmission of radio waves from the radio transmitter, wherein the processor performs the simulation repeatedly while changing the prescribed condition until a difference between the measurement result data and a result of the simulation at part of the plurality of measurement points becomes smaller than or equal to a prescribed value.

The disclosure also provides a radio wave environment analysis method in a radio wave environment analyzer, the radio wave environment analysis method including: preparing a memory which holds measurement result data in which radio wave environment measurement results are associated with position information of a plurality of measurement points, the radio wave environment measurement results being obtained at the respective measurement points as a result of transmission of radio waves from a radio transmitter installed in an area having the plurality of measurement points; performing, using prescribed conditions, a simulation of radio wave environments to be obtained at respective locations in the area as a result of transmission of radio waves from the radio transmitter; and performing the simulation repeatedly while changing the prescribed conditions until a difference between the measurement result data and a result of the simulation at part of the plurality of measurement points becomes smaller than or equal to a prescribed value.

The disclosure makes it possible to support visualization of a highly accurate radio wave environment simulation result through efficient cooperation between measurement results at a plurality of example measurement points and a simulation in an entire area that is a target of a radio wave environment simulation without making actual measurements in the entire area.

### BRIEF DESCRIPTION OF DRAWINGS

FIG. 1 is a block diagram showing an example hardware configuration of a radio wave environment display apparatus according to a first embodiment.

FIG. 2 is a diagram showing an example model area of a simulation to be performed by the radio wave environment display apparatus according to the first embodiment.

FIG. 3 is a perspective view showing an appearance of a radio wave measuring instrument.

FIG. 4 is a diagram showing a first visualization example of a radio wave environment simulation result in the model area shown in FIG. 2.

FIG. 5 is a diagram showing a second visualization example of a radio wave environment simulation result in the model area shown in FIG. 2.

FIG. 6 is a flowchart showing an example operation procedure of a radio wave environment analyzing process to be executed by the radio wave environment display apparatus according to the first embodiment.

### DETAILED DESCRIPTION

(Background Leading to First Embodiment)

Radio wave environments can be measured in an actual environment in a target area by, for example, as described in JP-A-2006-125951, mounting a device for detecting electric field strength on a cart and moving the cart physically. However, there are problems that work such as moving the cart occurs necessarily and a measurement takes time.

An example of a ray tracing method is disclosed in Tetsuro IMAI, “Mobile Radio Propagation Simulation Based on Ray-Tracing Method”, IEICE Transactions on Communications, Vol. J92-B, No. 9, pp. 1333-1347, September 2009 (hereinafter referred to as “IMAI”). The use of the ray tracing method makes it possible to analyze radio wave environments at small intervals because as described above a simulation of radio wave environments can be performed in a target area. However, it is difficult to perform a simulation taking into consideration the shapes etc. of scattering bodies actually arranged in the area; for example, a desk existing as one scattering body is regarded as a simple cuboid in a simulation. This results in a problem that it is not easy to reproduce radio wave environments faithfully.

In view of the above, an example radio wave environment analyzer and radio wave environment analysis method that enables both of an actual measurement and a simulation in an area as described above will be described as a first embodiment. More specifically, the example radio wave environment analyzer and the radio wave environment analysis method according to the first embodiment support visualization of a highly accurate radio wave environment simulation result through efficient cooperation between measurement results at a plurality of example measurement points (e.g., measurement points where a user wants to make observation; this also applies to the following description) and a simulation in an entire area that is a target of a radio wave environment simulation without making actual measurements in the entire area.

The embodiment as a specific disclosure of the radio wave environment analyzer and the radio wave environment analysis method according to the present disclosure will be described in detail by referring to the drawings when necessary. However, unnecessarily detailed descriptions may be avoided. For example, detailed descriptions of already well-known items and duplicated descriptions of constituent elements having substantially the same ones already described may be omitted. This is to prevent the following description from becoming unnecessarily redundant and thereby facilitate understanding of those skilled in the art. The following description and the accompanying drawings are provided to allow those skilled in the art to understand the disclosure thoroughly and are not intended to restrict the subject matter set forth in the claims.

The following embodiment will be described with an assumption that radio wave environment measurement locations (in other words, measurement points) selected by a user and at least one location (in other words, transmission point) where a radio transmitter (i.e., access point) is disposed are provided in a target area (hereinafter abbreviated as an “area”) of visualization of radio wave environments. The area may be either an indoor room or a wide area (e.g., outdoor area). In the following description, the term “radio wave environment” means reception quality at a location in an area that is calculated in analysis processing (in other words, simulation) that is performed by a radio wave environment display apparatus when radio waves are transmitted (radiated) from the radio transmitter disposed at the transmission point (mentioned above). For example, the reception quality means reception power (in other words, reception electric field strength) and an incoming direction.

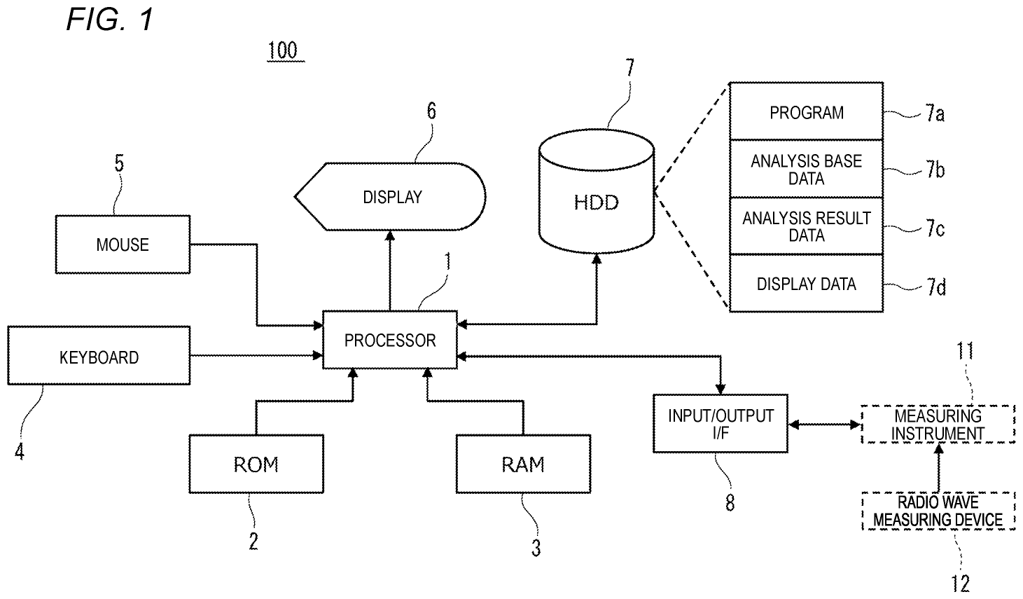

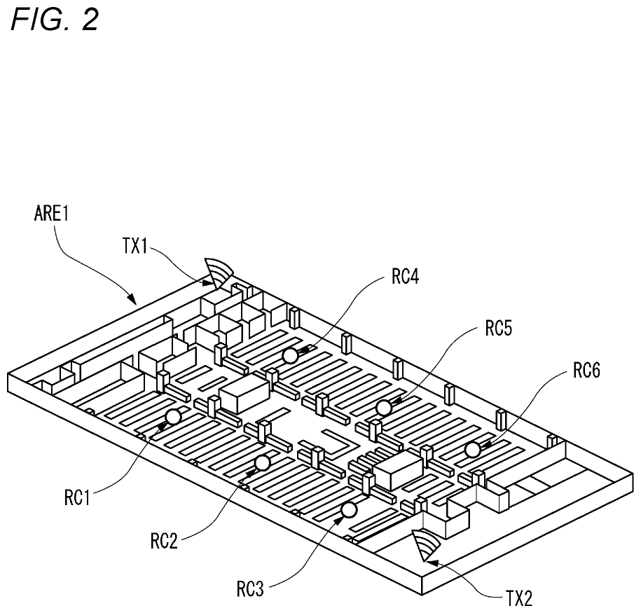

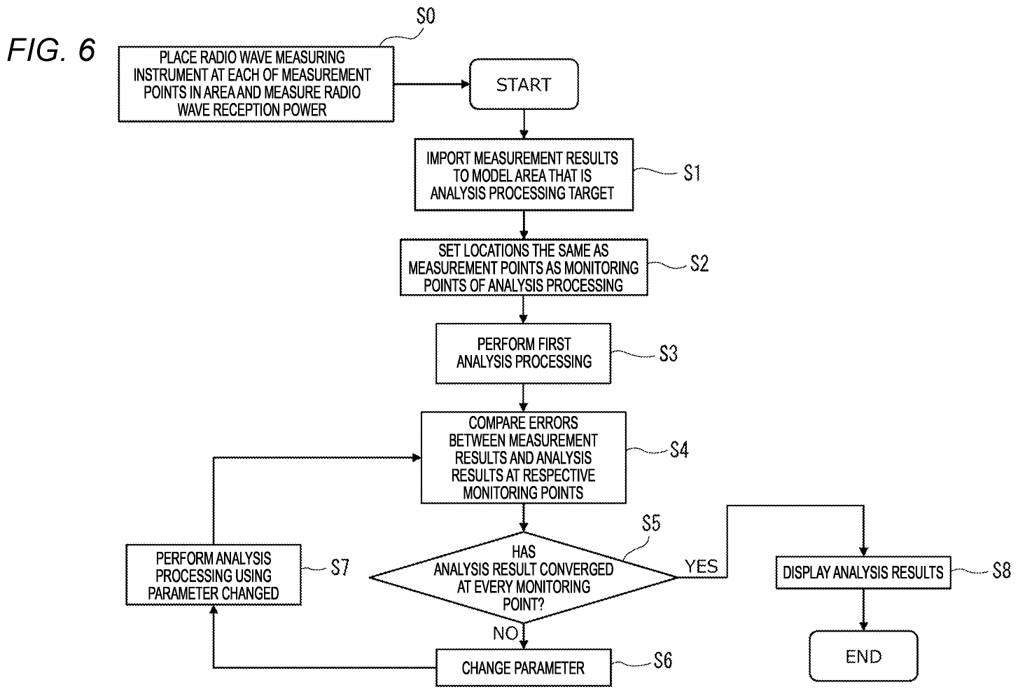

FIG. 1 is a block diagram showing an example hardware configuration of a radio wave environment display apparatus 100 according to the first embodiment. FIG. 2 is a diagram showing an example model area of a simulation to be performed by the radio wave environment display apparatus 100 according to the first embodiment. The radio wave environment display apparatus 100 as an example radio wave environment analyzer performs radio wave environment analysis processing using analysis base data 7b relating to an area ARE1 where transmission points (e.g., locations such as access points TX1 and TX2 where a radio transmitter is disposed) are located and actual radio wave environment measurement results at a plurality of example measurement points in the area ARE1 (see FIG. 6).

Although in the following description the plurality of example measurement points are six locations RC1, RC2, RC3, RC4, RC5, and RC6 in the area ARE1 shown in FIG. 2, the plurality of measurement points are not limited to these locations and even need not always be six locations. For example, the area ARE1 is an office room in which a plurality of scattering bodies such as desks, chairs, shelves, room partitions, etc. are arranged. The area ARE1 is not limited to an office room in which a plurality of scattering bodies are arranged and may be a wide area such as an outdoor area. For example, the access points TX1 and TX2 are located at diagonal end positions in the area ARE1.

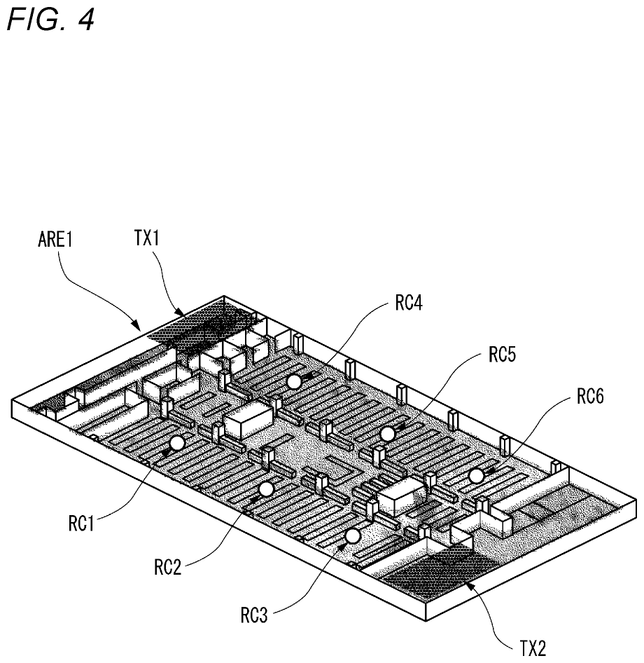

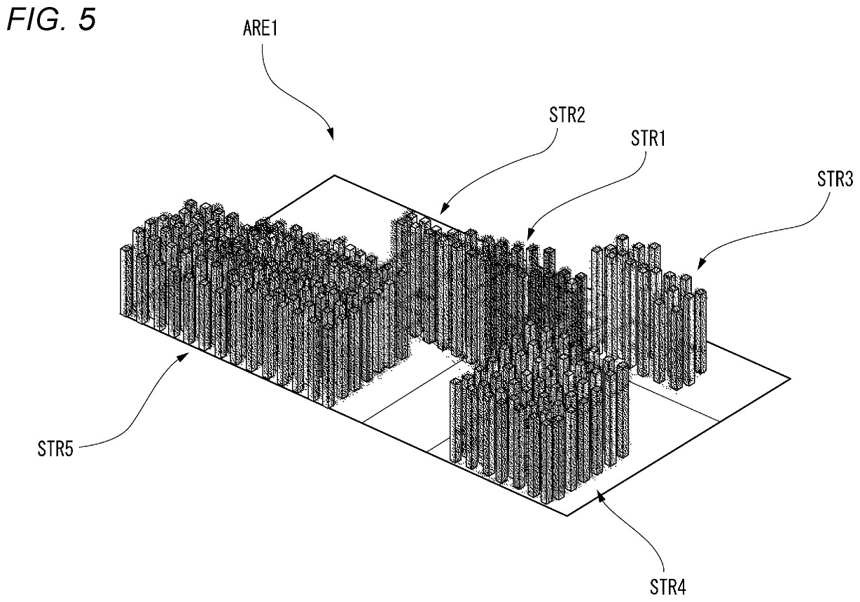

The term “radio wave environment analysis processing” means calculating reception quality (mentioned above) by simulating radio wave environments in a case that radio waves transmitted from the transmission points (access points TX1 and TX2) are received at the individual locations in the area ARE1. The radio wave environment display apparatus 100 displays analysis result data (e.g., a reception power distribution diagram showing at what reception power radio waves transmitted from each transmission point are received at each location in the area ARE1; see FIGS. 4 and 5).

The radio wave environment display apparatus 100 is configured so as to include a processor 1, a ROM 2, a RAM 3, a keyboard 4, a mouse 5, a display 6, an HDD (hard disk drive) 7, and an input/output interface (I/F) 8. The ROM 2, the RAM 3, the keyboard 4, the mouse 5, the display 6, the HDD 7, and the input/output interface 8 are connected to the processor 1 by an internal bus or the like so as to be able to exchange data or information with the processor 1. In FIG. 1, to simplify the description, the input/output interface is abbreviated as an “input/output I/F.”

For example, the processor 1 is configured using a CPU (central processing unit), an MPU (microprocessing unit), a DSP (digital signal processor), or an FPGA (field-programmable gate array). Functioning as a control unit of the radio wave environment display apparatus 100, the processor 1 performs control processing for controlling the operations of the individual units of the radio wave environment display apparatus 100 in a centralized manner, processing for exchanging data or information with the individual units of the radio wave environment display apparatus 100, data calculation processing, and processing of storing data or information. The processor 1 operates according to programs 7a stored in the HDD 7. The processor 1 uses the ROM 2 and the RAM 3 in performing processing, acquires current time information, and outputs analysis result data 7c generated by analysis processing (described later; see FIG. 6) to have the data displayed 6 thereon.

The ROM 2, which is a read-only memory, is stored with OS (operating system) programs and data in advance. The OS programs are run upon a start of the radio wave environment display apparatus 100.

The RAM 3, which is a writable and readable memory, is used as a work memory when various kinds of radio wave environment analysis processing (see FIG. 6) is executed and temporarily stores data or information that is used or generated during the various kinds of radio wave environment analysis processing.

The keyboard 4 and the mouse 5, which are example manipulation input units, function as human interfaces with a user and receive a user manipulation. In other words, the keyboard 4 and the mouse 5 are used for making an input or an instruction in various kinds of processing performed by the radio wave environment display apparatus 100.

The display 6, which is an example of a display unit, is configured using a display device such as an LCD (liquid crystal display) or an organic EL (electroluminescence) display. The display 6, which functions as a human interface with a user, displays display data 7d corresponding to details of various settings, an operation state of the radio wave environment display apparatus 100, and various calculation results and analysis results.

The HDD 7 stores the programs 7a for execution of radio wave environment analysis processing (see FIG. 6), analysis base data 7b to be used at the time of radio wave environment analysis processing, analysis result data 7c corresponding to an analysis result of radio wave environment analysis processing, and display data 7d generated on the basis of the analysis result data 7c. The analysis base data 7b include various kinds of data and/or information such as map or layout data in the area ARE1, scattering body data in which the number of scattering bodies (i.e., obstacles that interrupt propagation of radio waves) installed in the area ARE1, types (e.g., materials) of the scattering bodies, and material constants (e.g., reflectance or transmittance) are associated with one another, and locations of the radio transmitters (e.g., access points TX1 and TX2) in the area ARE1.

The programs 7a for analysis processing of radio wave environments in the area ARE1 is read out from the HDD 7 into the RAM 3 via the processor 1 and run by the processor 1. The programs 7a may be recorded in a recording medium (e.g., CD-ROM; not shown) other than the HDD 7 and read out into the RAM 3 by a corresponding reading device (e.g., CD-ROM drive; not shown).

More specifically, the analysis base data 7b used for analysis processing of radio wave environments in the area ARE1 as described above may include data and/or information, for example, as follows: (1) Data such as transmission power (dBm), a frequency, a modulation form, etc. of a signal transmitted from the radio transmitters (e.g., access points TX1 and TX2) located in the area ARE1, and an antenna gain and installation height; (2) data such as an antenna gain and installation height of a radio receiver that is assumed to exist at a certain location (i.e., virtual radio wave reception point) in the area ARE1; (3) data relating to a two-dimensional or three-dimensional size of the area ARE1; (4) scattering body data in which the number of scattering bodies (i.e., obstacles that interrupt propagation of radio waves) installed in the area ARE1, a three-dimensional sizes, material constants (e.g., reflectance or transmittance), and positions (i.e., sets of two-dimensional coordinates in the area ARE1) of the respective scattering bodies are associated with one another; and (5) setting value data of a lower limit value (e.g., −100 dBm) of reception quality (e.g., reception power) calculated on the basis of analysis processing.

The radio wave environment display apparatus 100 according to the first embodiment can calculate a radio wave incoming direction and reception power at each location in the area ARE1 on the basis of the above-mentioned analysis base data 7b according to a known ray tracing method (refer to IMAI, for example) or a known statistical estimation method, for example. Thus, in the first embodiment, a method for calculating a radio wave incoming direction and reception power at each location in the area ARE1 will not be described in detail.

The input/output interface 8, which functions as an interface for receiving and outputting data or information from and to the radio wave environment display apparatus 100, is configured using, for example, a connector that is physically connected to a measuring instrument 11, a cable, etc. In the first embodiment, the radio wave environment display apparatus 100 is connected to the measuring instrument 11 via the input/output interface 8. The above-mentioned cable includes a USB (Universal Serial Bus) cable (not shown), for example.

The measuring instrument 11 is connected, by a cable (not shown), to a radio wave measuring device 12 for receiving radio waves transmitted from the access points TX1 and TX2 located in the area ARE1. The measuring instrument 11 is also connected to the radio wave environment display apparatus 100 via the input/output interface 8. The measuring instrument 11 measures reception power (in other words, radio wave intensity) and measures a delay spread relating to reception of radio waves on the basis of a detection output of radio waves received by the radio wave measuring device 12. In measuring reception power, the measuring instrument 11 can measure radio wave intensity values of horizontally polarized waves and vertically polarized waves at each frequency on the basis of detection outputs of a horizontal polarization antenna and a vertical polarization antenna installed on respective surfaces of the radio wave measuring device 12 using a spectrum analyzer, for example. Furthermore, in measuring a delay spread, the measuring instrument 11 can determine a reflection wave incoming direction on the basis of detection outputs of the horizontal polarization antenna and the vertical polarization antenna installed on the respective surfaces of the radio wave measuring device 12 using, for example, a network analyzer and judge whether an obstacle (scattering body) such as a wall surface is absorbing radio waves.

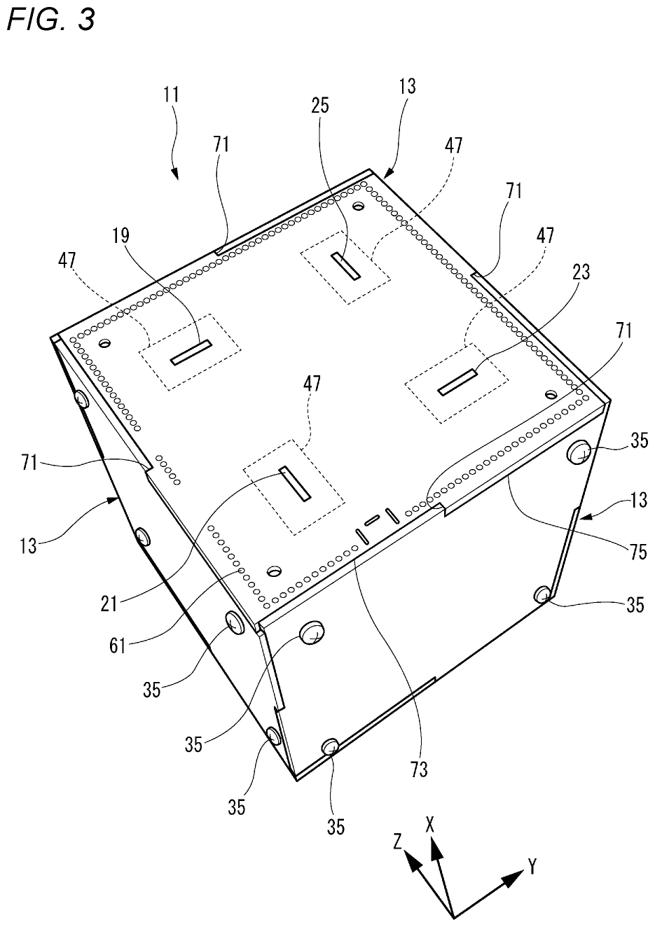

While actual radio wave environments at the locations (measurement points) RC1, RC2, RC3, RC4, RC5, and RC6 in the area ARE1, the radio wave measuring device 12 is moved so as to be placed at a prescribed height at the locations RC1, RC2, RC3, RC4, RC5, and RC6 in this order. When placed at each of the locations RC1, RC2, RC3, RC4, RC5, and RC6, the radio wave measuring device 12 receives radio waves transmitted from the access points TX1 and TX2 in the area ARE1 at the location RC1, RC2, RC3, RC4, RC5, or RC6. The radio wave measuring device 12 outputs a detection output (e.g., a characteristic such as a waveform of a reception signal) of the radio waves detected through the reception to the measuring instrument 11. The shape of the radio wave measuring device 12 will now be described with reference to FIG. 3.

FIG. 3 is a perspective view showing an appearance of the radio wave measuring device 12. In the first embodiment, the directions of the X axis, Y axis, and Z axis are defined as indicated by respective arrows shown in FIG. 3. Furthermore, for example, the +X direction and the −X direction correspond to the top-bottom direction of the body of the radio wave measuring device 12, the +Y direction and the −Y direction correspond to the left-right direction of the body of the radio wave measuring device 12, and the +Z direction and the −Z direction correspond to the front-rear direction of the body of the radio wave measuring device 12.

The radio wave measuring device 12 has, as major components, multilayer boards 13 which are example surface members and a frame body that is provided inside the body of the radio wave measuring device 12. The multilayer boards 13 and the frame body constitute the body, which assumes a polyhedron (e.g., hexahedron), of the radio wave measuring device 12. The body of the radio wave measuring device 12 assumes, for example, a hexahedron and a particular case that it assumes a cube is shown. The multilayer boards 13 are attached to the respective surfaces of a cube by fixing screws 35, for example.

The surface members that are parts of the body of the radio wave measuring device 12 are not limited to the multilayer boards 13. Furthermore, the polyhedron is not limited to a hexahedron and may be a tetrahedron, a dodecahedron, or the like.

In the radio wave measuring device 12, antennas are provided in one multilayer board 13 provided at the top, four multilayer boards 13 provided at the respective sides, and one multilayer board 13 provided at the bottom. Configured in this manner, the radio wave measuring device 12 can receive incoming radio waves in six directions in total. Where radio waves are measured by the radio wave measuring device 12 that is fixed to a prescribed mounting surface, the multilayer board 13 provided with antennas need not always be provided at the bottom of the radio wave measuring device 12. In FIG. 3, whereas the antennas provided on the above-mentioned multilayer board 13 provided at the top are shown, illustration of the antennas provided on the other surfaces (more specifically, the antennas provided on each of the above-mentioned four side surfaces and the antennas provided on the one bottom surface) are omitted.

The antennas provided on each laminated substrate 13 are dipole antennas, for example. The dipole antennas are formed, for example, on each laminated substrate 13 and each dipole antenna pattern is formed by, for example, etching a surface metal foil. Each of the plurality of layers is made of copper foil, glass epoxy, or the like.

For example, each of the laminated substrates 13 of the cubic body of the radio wave measuring device 12 is provided with, on its surface (as a top layer), a horizontal polarization antenna 19 of the 2.4 GHz band, a vertical polarization antenna 21 of the 2.4 GHz band, a horizontal polarization antenna 23 of the 5 GHz band, a vertical polarization antenna 25 of the 5 GHz band.

Each AMC 47, which is an artificial magnetic conductor having a PMC (perfect magnetic conductor) characteristic, is formed as a prescribed metal pattern. The use of the AMC 47 makes it possible to form each antenna of the radio wave measuring device 12 parallel with the associated laminated substrate 13 and to reduce its overall size. Furthermore, the AMC 47 makes it possible to prevent reception of radio waves from the other directions using a ground conductor and to thereby increase the antenna gain.

In the radio wave measuring device 12, grounding via conductors 61 are arranged straightly along each of the four sides (edges) of each laminated substrate 13. The grounding via conductors 61 may be arranged at the same intervals. The grounding via conductors 61 may be arranged at a pitch (interval) that is long enough to attain shielding from radio waves coming from outside the radio wave measuring device 12 for a frequency band (in other words, wavelengths) corresponding to the antenna conductors formed on the laminated substrate 13. The grounding via conductors 61 are formed so as to penetrate through the laminated substrate 13 from its top surface to its bottom surface.

In the radio wave measuring device 12, each laminated substrate 13 has a rectangular shape, for example. Each side of each laminated substrate 13 is formed with a recess 73 and a projection 75 that are bounded by one step 71 located at the center of the side and extend along the side. That is, in the body of the radio wave measuring device 12, as shown in FIG. 3, adjacent laminated substrates 13 are combined with each other in such a manner that their recess 73 and projection 75 are fitted with/into each other.

FIG. 4 is a diagram showing a first visualization example of a radio wave environment simulation result in the model area shown in FIG. 2. FIG. 5 is a diagram showing a second visualization example of a radio wave environment simulation result in the model area shown in FIG. 2. It goes without saying that FIGS. 4 and 5 show visualization examples of radio wave environment simulation results obtained by the radio wave environment display apparatus 100 according to the first embodiment and the manner of visualization is not limited to these visualization examples.

As described later in detail with reference to FIG. 6, the radio wave environment display apparatus 100 takes in actual radio wave environment measurement results obtained at a plurality of example measurement points (e.g., locations RC1, RC2, RC3, RC4, RC5, and RC6) in the area ARE1 and performs a simulation that is directed to the entire area ARE1. That is, the radio wave environment display apparatus 100 performs a simulation while changing various conditions (e.g., the material constants included in the scattering body data) employed in the simulation so that differences between simulation results and actual measurement results at the above-mentioned measurement points (e.g., locations RC1, RC2, RC3, RC4, RC5, and RC6) are made smaller. In this manner, by using measurement results at the actual measurement points, the radio wave environment display apparatus 100 can obtain highly accurate simulation results and increase the convenience of a user.

As shown in FIG. 4, as for a result of a radio wave environment simulation performed in the entire area ARE1 by the radio wave environment display apparatus 100, regions where the radio wave environment is the best (e.g., the reception power (intensity) is largest) are “painted out” in red, regions where the intensity is second highest are “painted out” in orange, and sets of regions where the intensity lowers in order are “painted out” in yellow, green, yellowish green, and blue, respectively. Respective regions where the access points TX1 and TX2 exist are “painted out” in red because they are close to the radio wave transmission locations. On the other hand, locations (e.g., locations RC2 and RC5) in the area ARE1 that are farthest from the locations where access points TX1 and TX2 exist are “painted out” in yellowish green or blue because the radio wave reception power (intensity) is smallest there. In this manner, in the visualization example shown in FIG. 4, a user can recognize, visually and simply, at what locations in the area ARE1 the radio wave reception power (intensity) is large or small.

The visualization example shown in FIG. 5 is an example of a case that the access points TX1 and TX2 are located at positions different from the positions (i.e., the positions of the transmission points) shown in FIG. 2. Attention should therefore be paid to the fact that the radio wave environment (e.g., reception power (intensity)) at each location in the area ARE1 of the visualization example shown in FIG. 4 is different from that at each location in the area ARE1 of the visualization example shown in FIG. 5. In FIG. 5, radio wave environments (e.g., reception power (intensity) values) in the area ARE1 are indicated as a bar graph. That is, the length of each bar corresponds to a radio wave environment (e.g., reception power (intensity)). FIG. 5 has bars STR1 that are “painted out” in red, bars STR2 that are “painted out” in orange, bars STR3 that are “painted out” in yellowish green, and bars STR4 and STR5 that are “painted out” in green; strength values are indicated by the respective colors in the same manner as in FIG. 4. Thus, the example shown in FIG. 5 indicates that the radio wave environment (e.g., reception power (intensity)) is the best in the region where the bars STR1 are used and, on the other hand, the radio wave environment (e.g., reception power (intensity)) is worst in the regions where the bars STR4 and STR5 are used. In this manner, also in the visualization example shown in FIG. 5, a user can recognize, visually and simply, at what locations in the area ARE1 the radio wave reception power (intensity) is large or small.

Next, the operation procedure of a radio wave environment analyzing process to be executed by the radio wave environment display apparatus 100 according to the first embodiment will be described with reference to FIG. 6. FIG. 6 is a flowchart showing an example operation procedure of a radio wave environment analyzing process to be executed by the radio wave environment display apparatus 100 according to the first embodiment. For example, the processor 1 of the radio wave environment display apparatus 100 executes the analyzing process following the operation procedure shown in FIG. 6.

As shown in FIG. 6, in the first embodiment, to increase the accuracy of an analyzing process to be executed by the radio wave environment display apparatus 100, the radio wave measuring device 12 is set at a plurality of example measurement points (more specifically, locations RC1, RC2, RC3, RC4, RC5, and RC6) in the area ARE1 shown in FIG. 2 and radio waves transmitted from the access points TX1 and TX2 are received by the radio wave measuring device 12. An actual radio wave environment at each of the plurality of example measurement points is measured by the measuring instrument 11 on the basis of an output of the radio wave measuring device 12 (S0). At step S0, an error setting value (e.g., 3 dB) to be used in making an analysis result convergence judgment at step S5 (described later) is set as an initial setting by a user manipulation.

After the execution of step S0, the radio wave environment display apparatus 100 imports measurement results obtained at step S0 (S1). More specifically, the radio wave environment display apparatus 100 sets, as a simulation model area, the entire area ARE1 where the actual measurements were carried out at step S0 and receives, as setting information for a simulation, the measurement results obtained at step S0. For example, the radio wave environment (e.g., reception power (intensity)) measurement results obtained at the respective locations RC1, RC2, RC3, RC4, RC5, and RC6 are used as comparison reference values for judgment as to coincidence or approximate coincidence with simulation reception power (intensity) values at the respective locations RC1, RC2, RC3, RC4, RC5, and RC6. Furthermore, the radio wave environment display apparatus 100 sets the locations RC1, RC2, RC3, RC4, RC5, and RC6 that were used for the measurement at step S0 as monitoring points of a simulation (radio wave environment analysis processing) (S2).

After the execution of step S2, the radio wave environment display apparatus 100 performs first radio wave environment analysis processing at the locations in the area ARE1 where the access points TX1 and TX2 are located using the actual measurement results at the six locations that were imported at step S1 and the analysis base data 7b (S3). That is, the radio wave environment display apparatus 100 calculates reception quality (e.g., reception power and an incoming direction) at each location of radio waves transmitted from the access points TX1 and TX2 on the basis of the actual measurement results at the six locations that were imported at step S1 and the analysis base data 7b and stores calculation results of reception power and an incoming direction at the respective locations in the area ARE1 in the HDD 7 as analysis result data 7c.

The radio wave environment display apparatus 100 compares errors (i.e., differences) between the analysis results of the first analysis processing performed at step S3 and the actual measurement results at the six locations (more specifically, locations RC1, RC2, RC3, RC4, RC5, and RC6) that were set as the monitoring points at step S2 (S4). On the basis of results of the comparison made at step S4, the radio wave environment display apparatus 100 judges whether the analysis result data has converged (i.e., whether the difference calculated at step S4 has become smaller than or equal to the preset error setting value (e.g., 3 dB)) at every monitoring point (i.e., every one of the locations RC1, RC2, RC3, RC4, RC5, and RC6 that were set at step S2) (S5). Although it is judged here whether the analysis result data 7c has converged at all of the locations RC1, RC2, RC3, RC4, RC5, and RC6 that were set at step S2, it may be judged whether the analysis result data 7c has converged at part of the locations RC1, RC2, RC3, RC4, RC5, and RC6 that were set at step S2. For example, the part of the locations may be only the one location RC3. Making a convergence judgment only at the one location RC3 makes it possible to shorten the analysis time by not causing convergence at the other locations while suppressing reduction of the accuracy of analysis results around the location RC3. For another example, the part of the locations may be only the three locations RC3, RC5, and RC6 that are close to each other. Making convergence judgments at the three locations RC3, RC5, and RC6 that are close to each other makes it possible to shorten the analysis time by not causing convergence at the other locations while suppressing reduction of the accuracy of analysis results around the three locations RC3, RC5, and RC6 that are close to each other.

If judging that the analysis result data 7c has not converged at every monitoring point (i.e., every one of the locations RC1, RC2, RC3, RC4, RC5, and RC6 that were set at step S2), the radio wave environment display apparatus 100 changes the parameters of the scattering body data (described above) included in the analysis base data 7b that were used in the simulation (i.e., radio wave environment analysis processing) (S6). For example, the radio wave environment display apparatus 100 changes the number of scattering bodies located at or around each monitoring point where the difference calculated at step S4 was not smaller than or equal to the prescribed error setting value or the material constants (e.g., reflectance or transmittance) of those scattering bodies according to user manipulations and updates the analysis base data 7b (S6).

After the execution of step S6, the radio wave environment display apparatus 100 performs radio wave environment analysis processing at the locations in the area ARE1 where the access points TX1 and TX2 are located using the analysis base data 7b including the parameters as changed according to the user manipulations (S7). That is, the radio wave environment display apparatus 100 calculates reception quality (e.g., reception power and an incoming direction) at each location of radio waves transmitted from the access points TX1 and TX2 on the basis of the actual measurement results at the six locations that were imported at step S1 and the analysis base data 7b updated at step S6 and stores calculation results of reception power and an incoming direction at the respective locations in the area ARE1 in the HDD 7 as analysis result data 7c. After the execution of step S7, the radio wave environment display apparatus 100 returns to step S4.

The radio wave environment display apparatus 100 executes step S8 if judging that the analysis result data 7c has converged at every monitoring point (i.e., every one of the locations RC1, RC2, RC3, RC4, RC5, and RC6 that were set at step S2) (S5: yes). That is, the radio wave environment display apparatus 100 executes the series of steps S4, S5, S6, and S7 repeatedly until it judges that the analysis result data 7c has converged at every monitoring point (i.e., every one of the locations RC1, RC2, RC3, RC4, RC5, and RC6).

If judging that the analysis result data 7c has converged at every measurement point (i.e., every one of the locations RC1, RC2, RC3, RC4, RC5, and RC6 that were set at step S2) (S5: yes), the radio wave environment display apparatus 100 finishes the radio wave environment analysis processing at the locations in the area ARE1. Furthermore, the radio wave environment display apparatus 100 displays, on the display 6, the analysis results (see FIG. 4 or 5) of the radio wave environment analysis processing at the locations in the area ARE1 (S8).

As described above, the radio wave environment display apparatus 100 according to the first embodiment holds, in the HDD 7 (an example of a term “memory”), measurement result data in which radio wave environment measurement results are associated with position information of plural measurement points, the radio wave environment measurement results being obtained at the respective measurement points as a result of transmission of radio waves from the access points TX1 and TX2 (examples of a term “radio transmitter”) provided in the area ARE1 having the plurality of measurement points. The radio wave environment display apparatus 100 performs, by means of the processor 1, a simulation of radio wave environments in the area ARE1 to be obtained at respective locations as a result of transmission of radio waves from the access points TX1 and TX2 using various parameters (an example of a term “prescribed condition”) used and actual radio wave environment measurement results obtained at the above-mentioned respective measurement points. The radio wave environment display apparatus 100 performs the simulation repeatedly while changing the above-mentioned prescribed condition until a difference between the measurement result data and a result (i.e., analysis result data 7c) of the simulation at each of the plurality of measurement points becomes smaller than or equal to the error setting value (an example of a term “prescribed value”).

With this configuration, the radio wave environment display apparatus 100 enables efficient cooperation between measurement results at the plurality of example measurement points (e.g., six locations RC1-RC6) and a simulation without actual measurements in, for example, the entire area ARE1 that is a target of a radio wave environment simulation using the radio wave measuring device 12 and the measuring instrument 11. As such, the radio wave environment display apparatus 100 can support visualization on the display 6 by obtaining a highly accurate radio wave environment simulation result because it performs a simulation repeatedly while changing the parameters until the difference between measurement result data at each measurement point and analysis result data 7c of a simulation at each measurement point becomes smaller than or equal to the prescribed error setting value.

The prescribed condition is a parameter that relates to one or more scattering bodies disposed in the area ARE1 and is used as a variable in the simulation performed by the radio wave environment display apparatus 100. With this measure, the radio wave environment display apparatus 100 can obtain a highly accurate radio wave environment simulation result with respect to the area ARE1 because it changes (updates) the parameter relating to the scattering body or bodies so that the difference between measurement result data and analysis result data 7c of a simulation at each measurement point becomes smaller than or equal to the prescribed error setting value.

The parameter is the number of scattering bodies disposed in the area ARE1. With this measure, the radio wave environment display apparatus 100 can obtain analysis result data 7c by a simulation that is suitable for the number of scattering bodies actually disposed in the area ARE1 because even if the number of scattering bodies in the area ARE1 is not a proper number at the time of a simulation the radio wave environment display apparatus 100 performs a simulation repeatedly while correcting (updating) the number.

Furthermore, the parameter is radio wave reflectance or transmittance of the scattering body or bodies. With this measure, the radio wave environment display apparatus 100 can obtain analysis result data 7c by a simulation that is suitable for the reflectance or transmittance of each scattering body actually disposed in the area ARE1 because even if the reflectance or transmittance of each scattering body disposed in the area ARE1 is not a proper value at the time of a simulation the radio wave environment display apparatus 100 performs a simulation repeatedly while correcting (updating) that number.

Although the various embodiments have been described above with reference to the drawings, it goes without saying that the disclosure is not limited to those examples. It is apparent that those skilled in the art could conceive various changes, modifications, replacements, additions, deletions, or equivalents within the confines of the claims, and they are naturally construed as being included in the technical scope of the disclosure, too. Constituent elements of the above-described various embodiments may be combined in a desired manner without departing from the spirit and scope of the invention.

The present application is based on Japanese Patent Application No. 2018-053516 filed on Mar. 20, 2018, the disclosure of which is invoked herein by reference.

The disclosure is useful as a radio wave environment analyzer and a radio wave environment analysis method that support visualization of a highly accurate radio wave environment simulation result through efficient cooperation between measurement results at a plurality of example measurement points and a simulation without making actual measurements in an entire area that is a target of a radio wave environment simulation.

1. A radio wave environment analyzer comprising:
a memory which holds measurement result data in which radio wave environment measurement results are associated with position information of a plurality of measurement points, the radio wave environment measurement results being obtained at the respective measurement points as a result of transmission of radio waves from a radio transmitter installed in an area having the plurality of measurement points; and
a processor configured to perform, using a prescribed condition, a simulation of radio wave environments in the area to be obtained at respective locations as a result of transmission of radio waves from the radio transmitter,
wherein the processor performs the simulation repeatedly while changing the prescribed condition until a difference between the measurement result data and a result of the simulation at part of the plurality of measurement points becomes smaller than or equal to a prescribed value.

2. The radio wave environment analyzer according to claim 1, wherein the prescribed condition comprises a parameter used as a variable in the simulation and relating to one or more scattering bodies disposed in the area.

3. The radio wave environment analyzer according to claim 2, wherein the parameter comprises the number of the one or more scattering bodies disposed in the area.

4. The radio wave environment analyzer according to claim 2, wherein the parameter comprises radio wave reflectance or transmittance of the one or more scattering bodies.

5. A radio wave environment analysis method in a radio wave environment analyzer, the radio wave environment analysis method comprising:
preparing a memory which holds measurement result data in which radio wave environment measurement results are associated with position information of a plurality of measurement points, the radio wave environment measurement results being obtained at the respective measurement points as a result of transmission of radio waves from a radio transmitter installed in an area having the plurality of measurement points;
performing, using prescribed conditions, a simulation of radio wave environments to be obtained at respective locations in the area as a result of transmission of radio waves from the radio transmitter; and
performing the simulation repeatedly while changing the prescribed conditions until a difference between the measurement result data and a result of the simulation at part of the plurality of measurement points becomes smaller than or equal to a prescribed value.
